(19) United States
(12) Patent Application Publication
(10) Pub. No.: US 2026/0021641 A1
(43) Pub. Date: Jan. 22, 2026

(54) METHOD FOR PRODUCING STRETCHED FILM

(71) Applicant: KANEKA CORPORATION, Osaka-shi (JP)

(72) Inventor: Hidenori KAMEI, Settsu-shi (JP)

(73) Assignee: KANEKA CORPORATION, Osaka-shi (JP)

(21) Appl. No.: 19/339,028

(22) Filed: Sep. 24, 2025

Related U.S. Application Data
(63) Continuation of application No. PCT/JP2024/010810, filed on Mar. 19, 2024.

(30) Foreign Application Priority Data
Mar. 24, 2023 (JP) 2023-047825
Sep. 21, 2023 (JP) 2023-154111

(51) Int. Cl. B29C 71/02; B29C 35/08; B29C 48/00; B29C 48/08; B29C 55/14; B29C 71/04; B29K 67/00; C08G 63/06

(52) U.S. Cl. CPC B29C 71/02; B29C 35/0805; B29C 48/0018; B29C 48/022; B29C 48/08; B29C 55/14; B29C 71/04; C08G 63/06; B29C 2035/0822; B29K 2067/00

(57) ABSTRACT

Provided is a method for producing a stretched film containing a poly(3-hydroxybutyrate) resin which exhibits less shrinkage on heating, including melting a film raw material containing the poly(3-hydroxybutyrate) resin with an extruder and molding the film raw material into a film shape; stretching the molded film in a specific direction; and heating the stretched film to a temperature in a range from (melting point of the poly(3-hydroxybutyrate) resin−40)° C. to (melting point of the poly(3-hydroxybutyrate) resin)° C. by a non-contact heating technique with a relaxation amount in the specific direction represented by the formula (i) of 9 to 50%, (i) Relaxation amount [%]={(film dimension in specific direction before heat treatment)−(film dimension in specific direction during heat treatment)}/(film dimension in specific direction before heat treatment)×100.

### TECHNICAL FIELD

The present invention relates to a method for producing a stretched film containing a poly(3-hydroxybutyrate) resin.

### BACKGROUND ART

Separate collection and composting of raw garbage have recently been promoted especially in Europe, and there is a demand for plastic products that can be composted together with raw garbage.

Additionally, environmental problems caused by waste plastics have become an issue of great concern. In particular, it has been found that a huge amount of plastics dumped at seas or carried into seas through rivers, etc. are drifting in the ocean on a global scale. Such plastics, which retain their shapes for a long period of time, are pointed out as having various harmful effects on the ecosystems, and examples of plastics-induced problems include: a phenomenon called ghost fishing where plastics catch or trap marine creatures; and eating disorder from which marine creatures having ingested plastics suffer due to the plastics remaining in their digestive organs.

Furthermore, a problem has also been pointed out that plastics are broken into microplastics by the action of ultraviolet rays or any other cause, then the microplastics adsorb hazardous compounds present in seawater, and marine creatures ingest the microplastics with the adsorbed compounds, so that hazardous substances are introduced into the food chain.

While the use of biodegradable plastics is expected for such marine pollution caused by plastics, a report compiled by the United Nations Environment Program in 2015 points out that plastics biodegradable by compost such as polylactic acid cannot be expected to be decomposed in a short period of time in actual oceans with low temperatures, and therefore cannot be taken as measures against marine pollution. Under such circumstances, poly(3-hydroxybutyrate) resins are materials that can undergo biodegradation even in seawater, and thus have attracted attention as materials that solve the above problems.

Meanwhile, as a technique for producing a thin and high-strength film, a method involving stretching a film is known. For example, to produce a stretched film from a general-purpose resin such as polypropylene, a molten resin is cooled and solidified on a cast roll to form a web, and then the web is preheated to a temperature at which the web can be stretched, and then the web is stretched, whereby a stretched film can be continuously produced with high productivity.

However, poly(3-hydroxybutyrate) resins are known as materials that are difficult to stretch due to their characteristics. Patent Literature 1 discloses a method for producing a biaxially stretched film containing a poly(3-hydroxybutyrate) resin with high productivity.

### CITATION LIST

### Patent Literature

PTL 1: JP 2022-062759 A
PTL 2: JP 2006-145912 A

### SUMMARY OF INVENTION

### Technical Problem

When a stretched film containing a poly(3-hydroxybutyrate) resin as a main component is used as, for example, a packaging film, the production process may include thermal bonding between stretched films for sealing contents, thermal fixing of ink after placing the ink on the stretched film for printing, and the like, but there is a problem that the stretched film shrinks due to such heating, and the sealed portion or printing is distorted.

Patent Literature 2 discloses that a reflective film containing an aliphatic polyester resin, an acrylic resin, and a fine powder filler is subjected to heat treatment at 90° C. to 160° C. after stretching in order to impart dimensional stability to the reflective film. However, even when a stretched film containing a poly(3-hydroxybutyrate) resin is subjected to the same heat treatment, shrinkage on heating cannot be sufficiently suppressed.

In view of the above current situation, an object of the present invention is to provide a method for producing a stretched film that contains a poly(3-hydroxybutyrate) resin and exhibits less shrinkage on heating.

### Solution to Problem

As a result of intensive studies to solve the above problems, the present inventors have found that a stretched film that contains a poly(3-hydroxybutyrate) resin and exhibits less shrinkage on heating can be produced by stretching a film containing a poly(3-hydroxybutyrate) resin and then performing a heat treatment under specific conditions. Based on this finding, the inventors have accomplished the present invention.

That is, the present invention relates to a method for producing a stretched film containing a poly(3-hydroxybutyrate) resin, the method including: a step of melting a film raw material containing the poly(3-hydroxybutyrate) resin with an extruder and then molding the film raw material into a film shape; a step of stretching the molded film in a specific direction; and a step of subjecting the stretched film to a heat treatment, in which the heat treatment is a treatment of heating the stretched film to (melting point of the poly(3-hydroxybutyrate) resin−40° C.) or more and (melting point of the poly(3-hydroxybutyrate) resin° C.) or less by a non-contact heating technique with a relaxation amount in the specific direction represented by a following formula (i) of 9 to 50%.

$$Relaxation amount [ \% ] = \{ ( film dimension in specific direction before heat treatment ) - ( film dimension in specific direction during heat treatment ) \} / ( film dimension in specific direction before heat treatment ) \times 100 \qquad ( i )$$

### Advantageous Effects of Invention

According to the present invention, it is possible to provide a method for producing a stretched film that contains a poly(3-hydroxybutyrate) resin and exhibits less shrinkage on heating

### BRIEF DESCRIPTION OF DRAWINGS

FIG. 1 is a diagram illustrating a concept of a relaxation amount of a film.

### DESCRIPTION OF EMBODIMENTS

Hereinafter, embodiments will be described, but the present invention is not limited to the following embodiments. The present embodiment relates to a method for producing a stretched film containing a poly(3-hydroxybutyrate) resin, the method including: a step of melting a film raw material containing the poly(3-hydroxybutyrate) resin with an extruder and then molding the film raw material into a film shape; a step of stretching the molded film in a specific direction; and a step of subjecting the stretched film to a heat treatment, wherein the heat treatment is a treatment of heating the stretched film to (melting point of the poly(3-hydroxybutyrate) resin−40° C.) or more and (melting point of the poly(3-hydroxybutyrate) resin° C.) or less by a non-contact heating technique with a relaxation amount in the specific direction represented by the following formula (i) of 9 to 50%.

Relaxation amount [%]={(film dimension in specific direction before heat treatment)−(film dimension in specific direction during heat treatment)}/(film dimension in specific direction before heat treatment)×100 (i)

### <Poly(3-Hydroxybutyrate) Resin>

The poly(3-hydroxybutyrate) resin is a polyester resin that is an aliphatic polyester resin producible from microorganisms and that has 3-hydroxybutyrate as a repeating unit. The poly(3-hydroxybutyrate) resin may be poly(3-hydroxybutyrate) having only 3-hydroxybutyrate as a repeating unit, or may be a copolymer of 3-hydroxybutyrate and another hydroxyalkanoate. The poly(3-hydroxybutyrate) resin may be a mixture of a homopolymer and one or more copolymers, or a mixture of two or more copolymers.

Examples of the poly(3-hydroxybutyrate) resin include poly(3-hydroxybutyrate), poly(3-hydroxybutyrate-co-3-hydroxyhexanoate) [this may hereinafter be referred to as P3HB3HH], poly(3-hydroxybutyrate-co-3-hydroxyvalerate) [this may hereinafter be referred to as P3HB3HV], poly(3-hydroxybutyrate-co-4-hydroxybutyrate) [this may hereinafter be referred to as P3HB4HB], poly(3-hydroxybutyrate-co-3-hydroxyoctanoate), and poly(3-hydroxybutyrate-co-3-hydroxyoctadecanoate). Among them, poly(3-hydroxybutyrate), poly(3-hydroxybutyrate-co-3-hydroxyhexanoate), poly(3-hydroxybutyrate-co-3-hydroxyvalerate), and poly(3-hydroxybutyrate-co-4-hydroxybutyrate) are preferable because they are industrially easily produced.

Furthermore, poly(3-hydroxybutyrate-co-3-hydroxyhexanoate) is preferable in that by changing the composition ratio of repeating units, the melting point and the degree of crystallinity can be changed to change physical properties such as Young's modulus and heat resistance, so that physical properties between polypropylene and polyethylene can be imparted, and the plastic is industrially easily produced and useful in terms of physical properties. In particular, among poly(3-hydroxybutyrate) resins having characteristics of being easily thermally decomposed under heating at 180° C. or more, poly(3-hydroxybutyrate-co-3-hydroxyhexanoate) is preferable from the viewpoint of being able to lower the melting point and enabling molding processing at a low temperature.

Examples of commercially available products of poly(3-hydroxybutyrate-co-3-hydroxyhexanoate) include “KANEKA Biodegradable Polymer PHBH” (registered trademark) of Kaneka Corporation.

When the poly(3-hydroxybutyrate) resin contains a copolymer of a 3-hydroxybutyrate unit and another hydroxyalkanoate unit, the average content ratio of the 3-hydroxybutyrate unit and that of the other hydroxyalkanoate unit accounting for among all monomer units constituting the poly(3-hydroxybutyrate) resin are preferably 3-hydroxybutyrate unit/the other hydroxyalkanoate=99/1 to 80/20 (mol %/mol %), more preferably 97/3 to 85/15 (mol %/mol %) from the viewpoint of achieving both strength and productivity of the stretched film.

The average content ratio of each monomer unit accounting for among all monomer units constituting the poly(3-hydroxybutyrate) resin can be determined by a method known to those skilled in the art, for example, the method described in paragraph [0047] of WO 2013/147139. The average content ratio means a molar ratio of each monomer unit accounting for among all monomer units constituting the poly(3-hydroxybutyrate) resin, and when the poly(3-hydroxybutyrate) resin is a mixture of two or more poly(3-hydroxybutyrate) resins, the average content ratio means a molar ratio of each monomer unit contained in the entire mixture.

The poly(3-hydroxybutyrate) resin may be a mixture of at least two poly(3-hydroxybutyrate) resins differing in the types and/or contents of constituent monomers.

The weight-average molecular weight of the poly(3-hydroxybutyrate) resin as a whole is not particularly limited. In terms of ensuring both the strength and the productivity of the stretched film, the weight-average molecular weight is preferably from 200,000 to 2,000,000 g/mol, more preferably 250,000 to 1,500,000 g/mol, and still more preferably 300,000 to 1,000,000 g/mol.

The weight-average molecular weight of the poly(3-hydroxybutyrate) resin can be measured as a polystyrene-equivalent molecular weight by gel permeation chromatography (HPLC GPC system manufactured by Shimadzu Corporation) using a chloroform solution. As the column in the gel permeation chromatography, a column suitable for measuring the weight-average molecular weight may be used.

The method for producing the poly(3-hydroxybutyrate) resin is not particularly limited, and may be either a production method by chemical synthesis or a microbial production method. Among them, the microbial production method is preferable. A known method can be applied to the microbial production method. Known examples of bacteria that produce copolymers of 3-hydroxybutyrate with other hydroxyalkanoates include Aeromonas caviae, which is a P3HB3HV- and P3HB3HH-producing bacterium, and Alcaligenes eutrophus, which is a P3HB4HB-producing bacterium. In particular, in order to increase the P3HB3HH productivity, Alcaligenes eutrophus AC32 (FERM BP-6038) (T. Fukui, Y. Doi, J. Bacteriol., 179, pp. 4821-4830 (1997) with a poly-3-hydroxyalkanoate (P3HA) synthase gene introduced is more preferred. Such a microorganism is cultured under suitable conditions to allow the microorganism to accumulate P3HB3HH in its cells, and the microbial cells accumulating P3HB3HH are used. Besides the above microorganisms, genetically-modified microorganisms with various poly(3-hydroxybutyrate) resin synthesis-related genes introduced may also be used in conformity with the intended type of poly(3-hydroxybutyrate) resin to be produced, and culture conditions including the type of a substrate may be optimized.

The poly(3-hydroxybutyrate) resin may be an unmodified resin, or may be a resin prepared by modifying an unmodified poly(3-hydroxybutyrate) resin using a raw material (hereinafter referred to as a “raw material for modification”) that reacts with a resin, such as a peroxide.

When a modified resin is used as a film raw material, a film raw material containing a poly(3-hydroxybutyrate) resin obtained by reacting a raw material for modification in advance may be molded into a film, or at the time of molding a film raw material including an unmodified poly(3-hydroxybutyrate) resin and a raw material for modification, the raw material for modification may be reacted with the resin. When the resin and the raw material for modification are reacted, the whole of the resin may be reacted with the raw material for modification, or a part of the resin may be reacted with the raw material for modification to afford a modified resin, and then the remaining unmodified resin may be added to the modified resin.

The raw material for modification is not particularly limited as long as it is a compound capable of reacting with the poly(3-hydroxybutyrate) resin, but an organic peroxide can be preferably used from the viewpoint of handleability and ease of controlling the reaction with the poly(3-hydroxybutyrate) resin.

Examples of the organic peroxide include diisobutyl peroxide, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, bis(4-t-butylcyclohexyl) peroxydicarbonate, bis(2-ethylhexyl) peroxydicarbonate, t-hexyl peroxyneodecanoate, t-butyl peroxyneodecanoate, t-butyl peroxyneoheptanoate, t-hexyl peroxypivalate, t-butyl peroxypivalate, di(3,5,5-trimethylhexanoyl) peroxide, dilauroyl peroxide, 1,1,3,3-tetramethylbutyl peroxy-2-ethylhexanoate, disuccinic acid peroxide, 2,5-dimethyl-2,5-bis(2-ethylhexanoylperoxy) hexane, t-hexyl peroxy-2-ethylhexanoate, di(4-methylbenzoyl) peroxide, dibenzoyl peroxide, t-butyl peroxy-2-ethylhexylcarbonate, t-butyl peroxyisopropylcarbonate, 1,6-bis (t-butylperoxycarbonyloxy) hexane, t-butyl peroxy-3,5,5-trimethylhexanoate, t-butyl peroxyacetate, t-butyl peroxybenzoate, t-amyl peroxy, 3,5,5-trimethylhexanoate, 2,2-bis(4,4-di-t-butylperoxycyclohexy) propane, and 2,2-di-t-butylperoxybutane. Among these, t-butyl peroxy-2-ethylhexylcarbonate and t-butyl peroxyisopropylcarbonate are preferred. Furthermore, a combination of two or more of these organic peroxides can also be used.

The organic peroxide is used in various forms such as a solid form and a liquid form, and may be a liquid form diluted with a diluent or the like. In particular, an organic peroxide in such a form that the organic peroxide can be easily mixed with the poly(3-hydroxybutyrate) resin (in particular, an organic peroxide being in a liquid form at room temperature (25° C.)) is preferable because it can be more uniformly dispersed in the poly(3-hydroxybutyrate) resin, and a local modification reaction therewith in a resin composition is easily suppressed.

The content of the poly(3-hydroxybutyrate) resin in the stretched film may be 50 wt % or more, 55 wt % or more, 60 wt % or more, 70 wt % or more, or 80 wt % or more. The upper limit of the content of the poly(3-hydroxybutyrate) resin is not limited and may be 100 wt % or less.

The stretched film may contain an additive that can be used together with the poly(3-hydroxybutyrate) resin as long as the effect of the invention is not impaired. Examples of such additives include colorants such as pigments and dyes, odor absorbers such as activated carbon and zeolite, flavors such as vanillin and dextrin, fillers, plasticizers, oxidation inhibitors, antioxidants, weather resistance improvers, ultraviolet absorbers, nucleating agents, lubricants, mold release agents, water repellents, antibacterial agents, and slidability improvers. Only one additive may be contained, or two or more additives may be contained. The content of the additives can be appropriately set by those skilled in the art according to the intended use thereof. Even when a poly(3-hydroxybutyrate) resin contains these additives, the melting point thereof is substantially the same as the melting point of the poly(3-hydroxybutyrate) resin.

Hereinafter, the nucleating agent, the lubricant, the filler, and the plasticizer will be described in more detail.

### (Nucleating Agent)

Examples of the nucleating agent include polyhydric alcohols such as pentaerythritol, galactitol, and mannitol; orotic acid, aspartame, cyanuric acid, glycine, zinc phenylphosphonate, and boron nitride. Among them, pentaerythritol is preferable from the viewpoint that the effect of promoting the crystallization of the poly(3-hydroxybutyrate) resin is particularly excellent. One nucleating agent may be used, or two or more nucleating agents may be used. The proportions of the nucleating agents used can be adjusted as appropriate according to the intended purpose.

The amount of the nucleating agent used is not particularly limited, but is preferably 0.1 to 5 parts by weight, more preferably 0.5 to 3 parts by weight, and still more preferably 0.7 to 1.5 parts by weight, based on 100 parts by weight of the total amount of the poly(3-hydroxybutyrate) resin.

### (Lubricant)

Examples of the lubricant include behenamide, oleamide, erucamide, stearamide, palmitamide, N-stearylbehenamide, N-stearylerucamide, ethylenebisstearamide, ethylenebisoleamide, ethylenebiserucamide, ethylenebislauramide, ethylenebiscapramide, p-phenylenebisstearamide, and a polycondensation product of ethylenediamine, stearic acid, and sebacic acid. Among these, behenamide and erucamide are preferred because they are particularly superior in the lubricating effect on the poly(3-hydroxybutyrate) resin. One lubricant may be used, or two or more lubricants may be used. The proportions of the lubricants used can be adjusted as appropriate according to the intended purpose.

The amount of the lubricant used is not particularly limited, but is preferably 0.01 to 5 parts by weight, more preferably 0.05 to 3 parts by weight, and still more preferably 0.1 to 1.5 parts by weight, based on 100 parts by weight of the total amount of the poly(3-hydroxybutyrate) resin.

### (Filler)

The inclusion of a filler can afford a stretched film with further enhanced strength. The filler may be either an inorganic filler or an organic filler, and both an inorganic filler and an organic filler may be used in combination. The inorganic filler is not particularly limited, and examples thereof include silicates, carbonates, sulfates, phosphates, oxides, hydroxides, nitrides, and carbon black. Only one inorganic filler may be used, or two or more inorganic fillers may be used in combination.

The content of the filler is not particularly limited, but is preferably 1 to 100 parts by weight, more preferably 3 to 80 parts by weight, still more preferably 5 to 70 parts by weight, and further preferably 10 to 60 parts by weight, based on 100 parts by weight of the total amount of the poly(3-hydroxybutyrate) resin. It is noted that the stretched film may not contain a filler.

### (Plasticizer)

Examples of the plasticizer include glycerin ester compounds, citrate ester compounds, sebacate ester compounds, adipate ester compounds, polyether ester compounds, benzoate ester compounds, phthalate ester compounds, isosorbide ester compounds, polycaprolactone compounds, and dibasic ester compounds. Among these, glycerin ester compounds, citrate ester compounds, sebacate ester compounds, and dibasic ester compounds are preferred because they are particularly superior in the plasticizing effect on the poly(3-hydroxybutyrate) resin. Examples of the glycerin ester compounds include glycerin diacetomonolaurate. Examples of the citrate ester compounds include tributyl acetylcitrate. Examples of the sebacate ester compounds include dibutyl sebacate.

Examples of the dibasic ester compounds include benzyl methyl diethylene glycol adipate. One plasticizer may be used, or two or more plasticizers may be used. The proportions of the plasticizers used can be adjusted as appropriate according to the intended purpose.

The amount of the plasticizer used is not particularly limited, but is preferably 1 to 20 parts by weight, more preferably 2 to 15 parts by weight, and still more preferably 3 to 10 parts by weight, based on 100 parts by weight of the total amount of the poly(3-hydroxybutyrate) resin. It is noted that the stretched film may not contain a plasticizer.

### (Other Resins)

The stretched film may contain another resin other than the poly(3-hydroxybutyrate) resin as long as the effect of the invention is not impaired. Examples of such another resin include aliphatic polyester resins such as poly(3-hydroxypropionate), poly(4-hydroxybutyrate), polybutylene succinate adipate, polybutylene succinate, polycaprolactone and polylactic acid, and aliphatic aromatic polyester resins such as polybutylene adipate terephthalate (PBAT), polybutylene sebatate terephthalate, and polybutylene azelate terephthalate. Only one other resin may contained, or two or more other resins may be contained.

The content of the other resin is not particularly limited, but may be 100 parts by weight or less, 80 parts by weight or less, 70 parts by weight or less, 50 parts by weight or less, 30 parts by weight or less, 20 parts by weight or less, 10 parts by weight or less, 5 parts by weight or less, or 1 part by weight or less, based on 100 parts by weight of the poly(3-hydroxybutyrate) resin. The lower limit of the content of the other resin is not particularly limited, and may be 0 parts by weight or more.

When the other resin is a resin having a melting point higher than that of the poly(3-hydroxybutyrate) resin, the lower limit of the content of thereof may be 10 parts by weight or more, 20 parts by weight or more, 50 parts by weight or more, or 65 parts by weight or more, based on 100 parts by weight of the poly(3-hydroxybutyrate) resin. The upper limit of the content of the other resin may be less than 100 parts by weight based on 100 parts by weight of the poly(3-hydroxybutyrate) resin.

### <Production of Stretched Film>

A stretched film containing the poly(3-hydroxybutyrate) resin of the present disclosure can be produced by the following production method. A production method including: a step of melting a film raw material containing the poly(3-hydroxybutyrate) resin with an extruder and then molding the film raw material into a film shape; a step of stretching the molded film in a specific direction; and a step of subjecting the stretched film to a heat treatment, wherein the heat treatment is a treatment of heating the stretched film to (melting point of the poly(3-hydroxybutyrate) resin−40° C.) or more and (melting point of the poly(3-hydroxybutyrate) resin° C.) or less by a non-contact heating technique with a relaxation amount in the specific direction represented by the following formula (i) of 9 to 50%.

$$Relaxation amount [ \% ] = \{ ( film dimension in specific direction before heat treatment ) - ( film dimension in specific direction during heat treatment ) \} / ( film dimension in specific direction before heat treatment ) \times 100 \qquad ( i )$$

### (Molding Step)

In the step of melting a film raw material containing a poly(3-hydroxybutyrate) resin with an extruder and then molding the film raw material into a film shape, the method of molding the film raw material into the film shape is not particularly limited, and a known production method may be appropriately used. Specific examples thereof include blown film molding T-die extrusion molding using an extruder equipped with a T-die, calendering, and rolling. Among them, blown film molding or T-die extrusion molding is suitable because a strip-shaped film can be produced thereby at high productivity. As the extruder, a single-screw extruder, a twin-screw extruder, or the like can be appropriately used.

The molding temperature is not particularly limited as long as the resin can be appropriately melted, and is, for example, preferably (the melting point of the poly(3-hydroxybutyrate) resin° C.) or more and (the melting point of the poly(3-hydroxybutyrate) resin+50° C.) or less, more preferably (the melting point of the poly(3-hydroxybutyrate) resin° C.) or more and (the melting point of the poly(3-hydroxybutyrate) resin+30° C.) or less, and still more preferably (the melting point of the poly(3-hydroxybutyrate) resin° C.) or more and (the melting point of the poly(3-hydroxybutyrate) resin+20° C.) or less. The “molding temperature” referred to herein indicates a resin temperature during the period from resin introduction into the extruder to resin discharge from the die. Generally, the resin temperature can be measured, for example, by a thermometer mounted on an adapter.

### (Blown Film Molding)

The “blown film molding” refers to a molding method in which a molten resin is extruded into the shape of a tube from an extruder fitted at its end with a cylindrical die, and immediately thereafter, a gas is blown into the tube to inflate the tube into the shape of a balloon, and the balloon is molded into a film. The blown film molding is not particularly limited, and can be performed using, for example, a common blown film molding machine for use in molding a thermoplastic resin into a film.

The “common blown film molding machine” refers to a molding machine including a single-screw extruder fitted with a cylindrical die. The single-screw extruder may be any single-screw extruder that melts and kneads an introduced raw material resin and discharges the kneaded resin at a constant rate while maintaining the kneaded resin at a desired temperature. The screw of the single-screw extruder is not particularly limited in shape, etc., but is preferably one including a mixing element in terms of kneading performance. In addition, the structure of the cylindrical die is also not particularly limited, but in particular, a spiral mandrel die is preferable because this is less prone to cause welding and easily attains thickness uniformity.

In the blown film molding, an air ring that blows air onto the exterior of the bubble can be used to solidify the discharged molten resin and stabilize the bubble. A suitable air blowing structure of the air ring is a slit-type structure including: a plurality of annular slits through which air is blown out; and chambers which are located between the slits to facilitate the stabilization of the bubble.

The blow-up ratio (hereinafter sometimes abbreviated as “BUR”) in the blown film molding is a value obtained by dividing the bubble's cross-sectional circumference by the die diameter. The lower limit of the BUR is preferably 1.5 or more, more preferably 1.7 or more, still more preferably 1.9 or more, and particularly preferably 2 or more from the viewpoint of enhancing the film strength. The upper limit of the BUR is preferably 5.5 or less, more preferably 4.5 or less, still more preferably 4.0 or less, and particularly preferably 3.5 or less from the viewpoint of molding stability.

### (T-Die Extrusion Molding)

The “T-die extrusion molding” refers to a molding method in which a molten resin is extruded into the film shape by an extruder from a slit-shaped discharge port onto a cast roll to form a film. The T die is not particularly limited, and a known T die can be appropriately used. For example, the T-die preferably has a discharge port so shaped as to extrude a film-shaped raw material, but is not particularly limited in shape. The shape of the discharge port is also not particularly limited.

In the T-die extrusion molding, a film-shaped raw material is extruded from the discharge port of the T-die. The shape of the raw material may be any film-like shape, and the thickness and width thereof are not particularly limited. The thickness is preferably about 20 μm to 600 μm because within this range, there is little thickness unevenness and cooling after extrusion is easy.

The melt viscosity of the raw material extruded from the discharge port of the T-die is not particularly limited, but is preferably 1500 Pa·sec or less because within this range, there is less thickness unevenness and the generation of a die line can be prevented. The melt viscosity can be measured appropriately in accordance with a known method.

The haul-off speed in the blown film molding and the T-die extrusion molding depends on the thickness and width of the film and the resin discharge rate and can be adjusted within a range over which the bubble stability can be ensured. In general, the haul-off speed is preferably 1 to 100 m/min.

The thickness of the film before stretching is not particularly limited, and may be appropriately set in consideration of the thickness, stretch ratio, strength, etc. of the intended stretched film. For example, the thickness is preferably 20 to 600 μm, more preferably 40 to 500 μm, and still more preferably 50 to 300 μm. The thickness of the film can be measured using a caliper.

### (Stretching Step)

In the step of stretching the molded film in a specific direction, the method thereof is not particularly limited as long as stretching is possible, and a known production method can be appropriately used.

The stretching direction in the stretching step is not particularly limited, and the film can be stretched in any direction in the plane of the film. When the stretched film of the present disclosure is a strip-shaped film, the stretching direction may be either the MD direction or the TD direction of the film, or may be both the MID direction and the TD direction. Stretching in one of the MD direction and the TD direction is referred to as uniaxial stretching, and stretching in both the MD direction and the TD direction is referred to as biaxial stretching. The MD direction is also called a machine direction, a flow direction, or a length direction. The TD direction is a direction perpendicular to the MD direction, and is also referred to as a vertical direction or a width direction.

The specific technique of stretching is not particularly limited, but a technique of stretching by elongating the film in the stretching direction is preferable. The phrase “elongating a film in the stretch direction” means drawing the film in the stretch direction. On the other hand, by use of a method of stretching a film by applying pressure in the thickness direction of a film, such as rolling in which a film is sandwiched between two rolls, the film is prone to stick to the rolls, so that the productivity of the stretched film may deteriorate.

The technique of stretching the film in the stretching direction is not particularly limited. In the case of batch-type stretching, the film can be gripped at both ends and stretched in the stretching direction.

When a film is stretched in the MD direction while being continuously transferred, for example, the stretching in the MD direction can be performed using a roll longitudinal stretching machine while making a difference in the rotation speed of rolls among a plurality of rolls which transfer the film. In this case, the stretch ratio in the MD direction can be determined by the ratio of the rotation speed of the roll after stretching to the rotation speed of the roll before stretching.

When a film is stretched in the TD direction while being continuously transferred, for example, the film can be stretched in the TD direction by operating a transverse stretching machine such as a clip-type tenter with the film clamped at both ends thereof in the width direction and drawing the film in the TD direction. In this case, the stretch ratio in the TD direction can be determined by the ratio of the distance between both end points in the width direction of the film clamped after stretching to the distance between both end points in the width direction of the film clamped before stretching.

The stretch ratio achieved in the step of stretching the molded film in a specific direction is not particularly limited, but is preferably 1.1 or more, more preferably 1.3 or more, still more preferably 1.5 or more, and particularly preferably 2 or more. The upper limit is not particularly limited, and the stretch ratio may be appropriately determined, but may be, for example, 8 or less, 7 or less, 5 or less, or 3 or less. Even when biaxial stretching is performed, the stretch ratio can be adopted for each of the MD direction and the TD direction.

The stretching temperature is not particularly limited as long as a film can be appropriately stretched, and may be changed according to the mechanical strength, surface properties, thickness accuracy, etc. required for the stretched film to be produced.

The stretching temperature is preferably 40° C. or more, more preferably 50° C. or more, and still more preferably 60° C. or more. The upper limit is merely required to be equal to or lower than the melting point of the poly(3-hydroxybutyrate) resin, and is preferably 150° C. or less, more preferably 145° C. or less, and still more preferably 140° C. or less. When the stretching temperature is within the above temperature range, the thickness unevenness of the resulting stretched film can be reduced, and the mechanical properties such as elongation rate, tear propagation strength, and flexural fatigue resistance can be improved. In addition, it is possible to prevent occurrence of a trouble such as sticking of a film to a roll.

The stretching temperature referred to herein indicates the film temperature during stretching. In general, the stretching temperature can be determined by measuring the temperature of the film body or the ambient temperature in the vicinity of the film using an infrared radiation thermometer, a thermo label, or a thermocouple.

The means for adjusting a film temperature at the time of stretching is not particularly limited, and for example, a non-contact heating technique such as a method of applying hot air heated within the above-described temperature range to a film under stretching, a method of heating a film under stretching using an auxiliary heating means such as an infrared heater, and a method of stretching a film in a heating furnace whose temperature is controlled within the above-described temperature range; and a contact heating method such as a method of bringing a film into contact with a roll heated within the above-described temperature range. One of these methods may be used alone, or two or more thereof may be combined.

In the method of bringing a film into contact with a roll heated within the above-described temperature range, hot air may be applied to the film between the upstream stretching roll and the downstream stretching roll in the MD direction.

As a method of applying hot air heated within the above-described temperature range to a film under stretching, it is preferable to use a floating-type heating method from the viewpoint of heating efficiency. The floating-type heating is a method of heating a film by blowing hot air from an upper nozzle and a lower nozzle to both surfaces of the film. A plurality of alternating upper and lower nozzles are directed towards the surfaces of the film, and the film can be heated by hot air blown from each of the upper and lower nozzles without contact of the film with any of the upper and lower nozzles.

In the method of heating a film under stretching using an auxiliary heater such as an infrared heater, the film surface and the inside of the film can be heated to the same temperature in a short time, and uniform stretching can be performed over the entire film.

The infrared radiation to be applied to the film may be an electromagnetic wave in a general infrared region and may be any of near-infrared radiation (wavelength=0.74 to 1.5 μm), midinfrared radiation (wavelength=1.5 to 3.0 μm), and far-infrared radiation (wavelength=3.0 μm to 1 mm).

In the method of bringing a film into contact with a roll heated to the above-described temperature range, when the film is stretched using two adjacent stretching rolls while the film is continuously transferred, the upstream stretching roll of the two adjacent stretching rolls may be heated to the above-described temperature range. In this case, the stretching temperature, that is, the film temperature during stretching can be controlled by setting the temperature of the roll to a target stretching temperature.

In the step of stretching the molded film in a specific direction and in the case where a strip-shaped film is biaxially stretched, because of superior productivity, especially, superior easiness in performing heating when producing a large amount of film, as to the order of stretching, stretching is preferably performed in the MD direction first and then in the TD direction, and as to the means for adjusting the film temperature during stretching, it is preferable to use a method of bringing the film into contact with a roll heated within the above-described temperature range during stretching in the MD direction, and a non-contact heating technique in which a heating tool heated within the above-described temperature range does not come into contact with the film during stretching in the TD direction.

### (Step of Performing Heat Treatment)

In the step of subjecting the stretched film to a heat treatment, the heat treatment is a treatment of heating the stretched film to (the melting point of the poly(3−hydroxybutyrate) resin−40° C.) or more and (the melting point of the poly(3-hydroxybutyrate) resin° C.) or less by a non-contact heating technique with a relaxation amount in the specific direction represented by the following formula (i) of 9 to 50%.

$$Relaxation amount [ \% ] = \{ ( film dimension in specific direction before heat treatment ) - ( film dimension in specific direction during heat treatment ) \} / ( film dimension in specific direction before heat treatment ) \times 100 \qquad ( i )$$

In the heat treatment step, the stretched film is heated with a specific relaxation amount in a specific direction. Relaxation in a specific direction is relaxation in a stretching direction. Immediately after stretching in a specific direction, orientation of crystals in the specific direction is strong, and a stretched film produced without the heat treatment step of the present disclosure exhibits particularly large shrinkage on heating in the specific direction, whereas a stretched film produced through the heat treatment step of the present disclosure exhibits sufficiently small shrinkage on heating in the specific direction.

Herein, relaxation refers to reducing the film dimension in a specific direction in which the film has been stretched in order to remove the stress in the stretching direction present in the film. The film dimension refers to a distance between two arbitrarily specified points in the film plane, and may be a distance from one end to the other end of the film. When the stretched film of the present disclosure is a strip-shaped film, the film dimension in the MD direction may be a distance between two arbitrarily specified points in the MD direction in the film plane, and the film dimension in the TD direction may be a distance between both end points in the width direction of the film. When slack occurs in the film during the heat treatment as described later, the film dimension is a linear distance between two arbitrarily specified points in the film plane, and may be a linear distance from one end to the other end of the film. In particular, the film dimension in the TD direction may be a linear distance between both end points in the width direction of the film.

When the film is relaxed using two adjacent rolls while the film is continuously transferred, the film dimension in the MID direction can be adjusted by making a difference between the rotation speeds of the two adjacent rolls. The film dimension in the TD direction can be adjusted by clamping both ends of the film in the width direction using a transverse stretching machine such as a clip-type tenter and changing the distance between the clamp portions.

Specifically, the relaxation amount [%] in the MD direction in the step of performing the heat treatment can be calculated by the following formula (i-i), and the relaxation amount [%] in the TD direction can be calculated by the following formula (i-ii).

$$Relaxation amount in MD direction [ \% ] = \{ ( rotation speed of upstream roll of two adjacent rolls ) - ( rotation speed of downstream roll of two adjacent rolls ) \} / ( rotation speed of upstream roll of two adjacent rolls ) \times 100 \qquad ( i - i )$$

$$Relaxation amount in TD direction [ \% ] = \{ ( distance between both end points in width direction of film before heat treatment ) - ( distance between both end points in width direction of film during heat treatment ) \} / ( distance between both end points in width direction of film before heat treatment ) \times 100 \qquad ( i - ii )$$

When biaxial stretching is performed in the stretching step, it is preferable to relax the film in the last stretching direction of the MID direction or the TD direction. Specifically, for example, in the case of stretching a film in the MID direction and then stretching the film in the TD direction, the orientation of crystals after the stretching in the TD direction is stronger in the TD direction. Therefore, by heating the film to a specific temperature range in a specific relaxation amount in the TD direction, a stretched film containing a poly(3-hydroxybutyrate) resin is obtained which exhibits little shrinkage on heating in either the MID direction or the TD direction.

The relaxation amount in the specific direction is merely required to be 9 to 50%, is preferably 9 to 40%, is preferably 9 to 30%, and is more preferably 9 to 20%. When the relaxation amount is less than 9%, the amount of shrinkage on heating of the resulting stretched film in the specific direction cannot be sufficiently suppressed, and when the relaxation amount is more than 50%, the film is slackened during the heat treatment, and the resulting stretched film may remain slackened after the heat treatment as well as the film may be broken by coming into contact with a production device including a heating appliance, so that a stretched film cannot be produced with high productivity.

In addition, when the production method of the present disclosure includes a step of performing a preliminary heat treatment described later, “before heat treatment” in the formula (i) can be read as “before preliminary heat treatment”, and “film dimension in a specific direction before heat treatment” in the formula (i) can be read as “film dimension in a specific direction before preliminary heat treatment”.

The heat treatment may be performed twice or more, and in that case, it is preferable to increase the relaxation amount in the specific direction stepwise. This is because shrinkage on heating in the specific direction in which the film has been stretched in the step of stretching the film can be particularly reduced. That is, it is preferable to make the difference between the n-th relaxation amount and the (n−1)-th relaxation amount larger than the difference between the (n−1)-th relaxation amount and the (n−2)-th relaxation amount, specifically, for example, make the difference between the second relaxation amount and the first relaxation amount larger than the first relaxation amount, and make the difference between the third relaxation amount and the second relaxation amount larger than the difference between the second relaxation amount and the first relaxation amount. This will be described below using mathematical expressions. For example, when the relaxation amount in the specific direction in the n-th heat treatment represented by the formula given above is represented by Rn (n is a natural number of 2 or more), 9%≤Rn≤50%, and preferably, when n=2, the following formula (1) is satisfied, and when n≥3, the following formula (2) is satisfied in the entire range where n is 3 or more and k or less (k is a natural number of 3 or more).

$$R 1 < R 2 - R 1 \qquad ( 1 )$$

$$R ( k - 1 ) - R ( k - 2 ) < Rk - R ( k - 1 ) ( n = k ( k \geq 3 ) ) \qquad ( 2 )$$

The relaxation amount Rn in the specific direction in the n-th heat treatment is specifically expressed by the following formula (iii).

$$Relaxation amount Rn [ \% ] = \{ ( film dimension in specific direction before heat treatment ) - ( film dimension in specific direction during n - th heat treatment ) \} / ( film dimension in specific direction before heat treatment ) \times 100 \qquad ( iii )$$

When the heat treatment is performed at least twice, the first two consecutive runs will be described in detail. It is preferable that the heat treatment includes a step of changing the relaxation amount in the specific direction represented by the above formula to R2 after R1, and the relaxation amounts R1 and R2 satisfy 9%≤R1≤50%, 9%≤R2≤50%, and R1<R2-R1. Further, R2 more preferably satisfies 9%≤R2≤30%. By increasing the relaxation amount in the specific direction stepwise, shrinkage on heating in the specific direction in which the film has been stretched in the step of stretching the film can be further reduced.

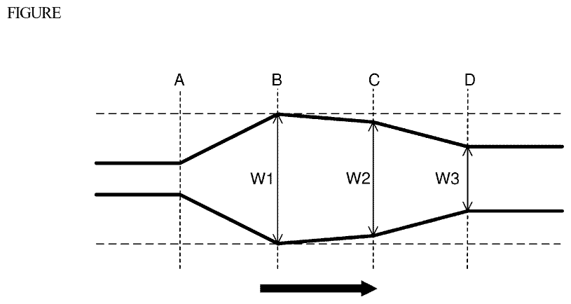

FIG. 1 is a diagram illustrating the concept of a relaxation amount of a film, and illustrates a case where the heat treatment step is performed twice as an example. The filled arrow in FIG. 1 indicate the MD direction of a film, the region between A and B indicates a step of stretching the film in the TD direction, the region between B and C indicates the first heat treatment step, the region between C and D indicates the second heat treatment step, and the steps A to D are performed in a continuous process. W1 represents a film dimension in a specific direction before heat treatment (after stretching in FIG. 1), W2 represents a film dimension during the first heat treatment, and W3 represents a film dimension during the second heat treatment. The relaxation amount R1 [%] during the first heat treatment can be calculated as (W1-W2) W1×100, and the relaxation amount R2 [%] during the second heat treatment can be calculated as (W1-W3)/W1×100.

The means for heating the film in the heat treatment is not particularly limited as long as it is a non-contact heating technique. Examples thereof include a method of applying hot air heated within the above-described temperature range to the film, a method of heating the film using an auxiliary heating means such as an infrared heater, and a method of heating the film by putting the film in a heating furnace whose temperature is adjusted within the above-described temperature range. One of these methods may be used alone, or two or more thereof may be combined. In the case of the non-contact heating technique, a high film temperature is easily attained, the temperature range of (the melting point of the poly(3-hydroxybutyrate) resin−40° C.) or more and (the melting point of the poly(3-hydroxybutyrate) resin° C.) or less is easily adjusted, and the problem of sticking of the film to a heating appliance can also be avoided.

The method of applying hot air heated within the above-described temperature range to the film, that is, hot air heating is a method of applying hot air heated to a temperature range of (the melting point of the poly(3-hydroxybutyrate) resin−40° C.) or more and (the melting point of the poly(3-hydroxybutyrate) resin° C.) or less to the film, and it is preferable to use a floating-type heating method.

The method of heating the film using the infrared heater, that is, infrared radiation heating is a method of heating the film to the temperature range using the infrared heater, and the same infrared rays as those to be applied at the time of stretching the film can be used as the infrared rays to be applied.

In the step of performing the heat treatment, the stretched film is heated to a temperature of (the melting point of the poly(3-hydroxybutyrate) resin−40° C.) or more and (the melting point of the poly(3-hydroxybutyrate) resin° C.) or less. If the temperature is lower than (the melting point of the poly(3-hydroxybutyrate) resin−40° C.), the amount of shrinkage on heating the resulting stretched film in the specific direction increases, whereas if the temperature is higher than (the melting point of the poly(3-hydroxybutyrate) resin° C.), the orientation of crystals obtained by stretching is lost, so that the mechanical strength of the resulting stretched film may decrease or the stretched film may be melted and broken.

The film temperature in the step of performing the heat treatment is preferably (the melting point of the poly(3-hydroxybutyrate) resin−40)° C. or more and (the melting point of the poly(3-hydroxybutyrate) resin° C.) or less, more preferably (the melting point of the poly(3-hydroxybutyrate) resin−40° C.) or more and (the melting point of the poly(3-hydroxybutyrate) resin−10° C.) or less, and still more preferably (the melting point of the poly(3-hydroxybutyrate) resin−40° C.) or more and (the melting point of the poly(3-hydroxybutyrate) resin−20° C.) or less. Under such conditions, it is possible particularly to reduce the risk of film breakage due to melting of the resin.

The film temperature in the step of performing the heat treatment is preferably (the melting point of the poly(3-hydroxybutyrate) resin−40° C.) or more and (the melting point of the poly(3-hydroxybutyrate) resin° C.) or less, more preferably (the melting point of the poly(3-hydroxybutyrate) resin−30° C.) or more and (the melting point of the poly(3-hydroxybutyrate) resin° C.) or less, and still more preferably (the melting point of the poly(3-hydroxybutyrate) resin−20° C.) or more and (the melting point of the poly(3-hydroxybutyrate) resin° C.) or less. This makes it possible to further reduce shrinkage on heating in the specific direction in which the film has been stretched in the step of stretching the film.

Preferably, the heat treatment includes a treatment of bringing the film to a temperature T1 and then to a temperature T2, and the temperatures T1 and T2 satisfy a condition represented by the formula given below. It is particularly preferable that a step of adjusting the relaxation amount in the specific direction represented by the above formula to R1, and then to R2 is included, and under conditions where the relaxation amounts R1 and R2 satisfy 9%<R1≤50%, 9%≤R2≤50%, and R1<R2-R1, the film is adjusted to a temperature T1 with the relaxation amount R1 and the film is adjusted to a temperature T2 with the relaxation amount R2.

### (Melting Point of Poly(3-Hydroxybutyrate) Resin−40)° C.≤T1<T2≤(Melting Point of Poly(3-Hydroxybutyrate) Resin° C.) or Less

By increasing the temperature of the heat treatment stepwise, film shrinkage due to rapid progress of crystallization can be suppressed, so that the risk of film breakage can be further reduced.

The melting point of the poly(3-hydroxybutyrate) resin refers to the peak temperature of the melting point peak in a DSC curve obtained by differential scanning calorimetry. The details of differential scanning calorimetry are described in the section of Examples.

The heating time in the step of performing the heat treatment is not particularly limited, but for example, from the viewpoint of productivity, the heating time is preferably 1 to 180 seconds, more preferably 1 to 30 seconds, and still more preferably 1 to 10 seconds.

### (Step of Performing Preliminary Heat Treatment)

A step of performing a preliminary heat treatment may be included before the step of performing the heat treatment. The preliminary heat treatment refers to a treatment in which the stretched film is heated to (the melting point of the poly(3-hydroxybutyrate) resin−40° C.) or more and (the melting point of the poly(3-hydroxybutyrate) resin° C.) or less by a non-contact heating technique in a relaxation amount of 0% or more and less than 9% in the specific direction represented by the following formula (ii). Due to the inclusion of the step of performing the preliminary heat treatment, shrinkage on heating in the specific direction in which the film has been stretched in the step of stretching the film can be particularly reduced. In addition, the risk of film breakage can be further reduced.

$$Relaxation amount [ \% ] = \{ ( film dimension in specific direction before preliminary heat treatment ) - ( film dimension in specific direction during preliminary heat treatment ) \} / ( film dimension in specific direction before preliminary heat treatment ) \times 100 \qquad ( ii )$$

Specifically, the relaxation amount [%] in the MID direction in the preliminary heat treatment step can be calculated by the following formula (ii-i), and the relaxation amount [%] in the TD direction can be calculated by the following formula (ii-ii).

$$Relaxation amount in MD direction [ \% ] = \{ ( rotation speed of upstream roll of two adjacent rolls ) - ( rotation speed of downstream roll of two adjacent rolls ) \} / ( rotation speed of upstream roll of two adjacent rolls ) \times 100 \qquad ( ii - i )$$

$$Relaxation amount in TD direction [ \% ] = \{ ( distance between both end points in width direction of film before preliminary heat treatment ) - ( distance between both end points in width direction of film during preliminary heat treatment ) \} / ( distance between both end points in width direction of film before preliminary heat treatment ) \times 100 \qquad ( ii - ii )$$

The relaxation amount in the specific direction represented by the formula (ii) in the preliminary heat treatment is merely required to be 0% or more and less than 9%, but is preferably 5% or less, more preferably 3% or less, still more preferably 1% or less, and most preferably 0%.

The means for heating the film in the preliminary heat treatment is not particularly limited as long as it is a non-contact heating technique, and may be the same as the means for heating the film in the heat treatment.

Preferred ranges of the film temperature and the heating time in the preliminary heat treatment are common to the preferred ranges of the film temperature and the heating time in the heat treatment step.

The amount of shrinkage on heating in the stretching direction when the stretched film produced by the production method of the present disclosure is heated at 110° C. for 10 minutes is preferably less than 10%, more preferably 8% or less, and still more preferably 6% or less. Preferably, the amount of shrinkage on heating is as small as possible, but it may be 0% or more, or 1% or more. The details of the method for measuring the amount of shrinkage on heating are as described in the section of Examples.

The production method of the present disclosure may include a step of cooling the film after the step of heat-treating the film. The film temperature in the step of cooling the film may be 100° C. or less, and is preferably 50° C. or more and 90° C. or less. The means for making the film temperature lower than the temperature of the heat treatment described above is not particularly limited as long as this purpose is achieved, and examples thereof include a method using the non-contact heating technique at an adjusted temperature of 100° C. or less, preferably 50° C. or more and 90° C. or less. Due to the inclusion of the step of cooling the film, it is possible to suppress the occurrence of wrinkles caused by a rapid decrease in the film temperature and a rapid shrinkage of the film associated therewith.

From the viewpoint of productivity, the production method of the present disclosure is preferably conducted in a continuous process from the step of melting a film raw material with an extruder and then molding the melted film raw material into a film shape to the step of performing a heat treatment, especially, to the acquisition of a stretched film. Herein, the continuous process refers to acquiring a stretched film by sequentially performing a step of melting a film raw material with an extruder and then molding the melted film raw material into a film shape, a step of stretching the molded film, a step of heat-treating the stretched film, and, as necessary, a step of cooling the film.

### <Thickness of Stretched Film>

The thickness of the stretched film is not particularly limited, and may be appropriately set to a desired thickness. From the viewpoint of uniform thickness, appearance, strength, lightness, etc. of the film, the thickness is preferably 10 to 200 μm, more preferably 15 to 150 μm, and still more preferably 20 to 100 μm. The thickness of the film can be measured using a caliper.

Since the stretched film of the present disclosure has high strength even if it is thin, it can be suitably used as a packaging film, for example, a packaging film for foods and the like for which heat sealability is required.

In the following items, preferred aspects of the present disclosure are listed, but the present invention is not limited to the following items.

[Item 1] A method for producing a stretched film containing a poly(3-hydroxybutyrate) resin, the method including:
a step of melting a film raw material containing the poly(3-hydroxybutyrate) resin with an extruder and then molding the film raw material into a film shape;
a step of stretching the molded film in a specific direction; and
a step of subjecting the stretched film to a heat treatment, in which
the heat treatment is a treatment of heating the stretched film to (melting point of the poly(3-hydroxybutyrate) resin−40° C.) or more and (melting point of the poly(3-hydroxybutyrate) resin)° C. or less by a non-contact heating technique with a relaxation amount in the specific direction represented by a following formula (i) of 9 to 50%.

$$Relaxation amount [ \% ] = \{ ( film dimension in specific direction before heat treatment ) - ( film dimension in specific direction during heat treatment ) \} / ( film dimension in specific direction before heat treatment ) \times 100 \qquad ( i )$$

[Item 2] The production method according to item 1, in which a time of heating in the step of performing the heat treatment is 1 to 180 seconds.

[Item 3] The production method according to item 1 or 2, in which the non-contact heating technique is hot air heating or infrared radiation heating.

[Item 4] The production method according to any one of items 1 to 3, in which the stretching is biaxial stretching.

[Item 5] The production method according to any one of items 1 to 4, in which the step of the molding through the step of the heat treatment are performed in a continuous process.

[Item 6] The production method according to any one of items 1 to 5, in which a stretch ratio of the film in the specific direction in the step of the stretching is 1.1 to 8.

[Item 7] The production method according to any one of items 1 to 6, in which the poly(3-hydroxybutyrate) resin includes poly(3-hydroxybutyrate-co-3-hydroxyhexanoate).

[Item 8] The production method according to any one of items 1 to 7, including a step of performing a preliminary heat treatment before the step of performing the heat treatment, in which the preliminary heat treatment is a treatment of heating the stretched film to (melting point of poly(3-hydroxybutyrate) resin−40° C.) or more and (melting point of poly(3-hydroxybutyrate) resin° C.) or less by a non-contact heating technique with a relaxation amount in the specific direction represented by the following formula (ii) of 0% or more and less than 9%.

$$Relaxation amount [ \% ] = \{ ( film dimension in specific direction before preliminary heat treatment ) - ( film dimension in specific direction during preliminary heat treatment ) \} / ( film dimension in specific direction before preliminary heat treatment ) \times 100 \qquad ( ii )$$

[Item 9] The production method according to any one of items 1 to 8, in which in the step of subjecting the stretched film to a heat treatment,
when the heat treatment is performed twice or more, and when a relaxation amount in the specific direction represented by the formula in the n-th heat treatment is represented by Rn (n is a natural number of 2 or more),

$$9 \% \leq Rn \leq 50 \% ,$$

when n=2, the following formula (1) is satisfied, and
when n=3, n satisfies the following formula (2) in the entire range of 3 or more and k or less (k is a natural number of 3 or more).

$$R 1 < R 2 - R 1 \qquad ( 1 )$$

$$R ( k - 1 ) - R ( k - 2 ) < Rk - R ( k - 1 ) ( n = k ( k \geq 3 ) ) \qquad ( 2 )$$

[Item 10] The production method according to any one of items 1 to 9, in which in the step of subjecting the stretched film to the heat treatment,
the heat treatment includes a step of adjusting the relaxation amount in the specific direction represented by the formula given above to R1 and then to R2, and
the relaxation amounts R1 and R2 satisfy 9%≤R1≤50%, 9%≤R2≤50%, and R1<R2-R1.

[Item 11] The production method according to item 10, in which in the step of subjecting the stretched film to the heat treatment,
the relaxation amount R2 satisfies 9%≤R2≤30%.

[Item 12] The production method according to any one of items 1 to 11, in which the heat treatment includes a treatment of bringing the film to a temperature T1 and then to a temperature T2, and the temperatures T1 and T2 satisfy a condition represented by the following formula.

$$( Melting point of poly ( 3 - hydroxybutyrate ) resin - 40 ) °C . \leq T 1 < T 2 \leq ( melting point of poly ( 3 - hydroxybutyrate ) resin ) °C . or less$$

[Item 13] The production method according to item 12,
in which in the step of subjecting the stretched film to the heat treatment, the heat treatment includes a step of adjusting the relaxation amount in the specific direction represented by the formula to R1, and then to R2,
the relaxation amounts R1 and R2 satisfy 9%≤R1≤50%, 9%≤R2≤50%, and R1<R2-R1, and
the film is adjusted to a temperature T1 with the relaxation amount R1, and the film is adjusted to a temperature T2 with the relaxation amount R2.

### EXAMPLES

Hereinafter, the present disclosure will be described more specifically using Examples and Comparative Examples, but the present invention is not limited by Examples at all.

In Examples and Comparative Examples, the following raw materials were used.

### (Poly (3-Hydroxybutyrate) Resin)

As the poly(3-hydroxybutyrate) resin, the following poly(3-hydroxybutyrate-co-3-hydroxyhexanoate) (P3HB3HH) resins A-1 to A-4 were used. The following 3HB represents a 3-hydroxybutyrate repeating unit, and 3HH represents a 3-hydroxyhexanoate repeating unit.
A-1: P3HB3HH (average content ratio: 3HB/3HH=97.2/2.8 (mol %/mol %), glass transition temperature: 6° C.)

This resin was produced in accordance with the method described in Example 2 of WO 2019/142845, and the weight-average molecular weight was adjusted to 660,000 g/mol by an aqueous sodium hydroxide solution treatment.
A-2: P3HB3HH (average content ratio: 3HB/3HH=71.8/28.2 (mol %/mol %), glass transition temperature: 1° C.)

This resin was produced in accordance with the method described in Example 9 of WO 2019/142845, and the weight-average molecular weight was adjusted to 660,000 g/mol by an aqueous sodium hydroxide solution treatment.
A-3: P3HB3HH (average content ratio: 3HB/3HH=94/6 (mol %/mol %), glass transition temperature: 6° C.)

This resin was produced in accordance with the method described in Example 1 of WO 2019/142845, and the weight-average molecular weight was adjusted to 600,000 g/mol by an aqueous sodium hydroxide solution treatment.
A-4: P3HB3HH (average content ratio: 3HB/3HH=94/6 (mol %/mol %), glass transition temperature: 6° C.)

This resin was produced in accordance with the method described in Example 1 of WO 2019/142845, and the weight-average molecular weight was adjusted to 400,000 g/mol by an aqueous sodium hydroxide solution treatment.
A-5: P3HB3HH (average content ratio: 3HB/3HH=89/11 (mol %/mol %), glass transition temperature: 6° C.)

This resin was produced in accordance with the method described in Example (raw material A-3) of WO 2013/147139, and the weight-average molecular weight was adjusted to 800,000 g/mol by an aqueous sodium hydroxide solution treatment.

### (Lubricant)

B-1: Behenamide (BNT-22H manufactured by Nippon Fine Chemical Co., Ltd.)

### (Nucleating Agent)

C-1: Pentaerythritol (Neulizer P manufactured by Mitsubishi Chemical Corporation)

### (Method for Producing Resin Composition)

### Resin Pellet P-1

30 parts by weight of A-1, 30 parts by weight of A-2, 10 parts by weight of A-3, and 30 parts by weight of A-4, 100 parts by weight in total, as a poly(3-hydroxybutyrate) resin were dry-blended with 0.5 parts by weight of B-1 as a lubricant and 1.0 parts by weight of C-1 as a nucleating agent. The resulting dry blend was charged into a 26-mm-diameter corotating twin-screw extruder hopper whose cylinder temperature and die temperature were set to 150° C., melt-kneaded, and extruded through a die into a strand form. The strand was passed through a water bath filled with 45° C. warm water to solidify, and cut with a pelletizer, whereby resin pellets P-1 were obtained. The melting point of the resin pellets P-1 was 153° C. The melting point of the poly(3-hydroxybutyrate) resin, which was a mixture of A-1 to A-4, was also 153° C.

### Resin Pellet P-2

Resin pellets P-2 were obtained in the same manner as the resin pellets P-1 except that the dry blend was obtained by dry-blending 60 parts by weight of A-3 and 40 parts by weight of A-5, 100 parts by weight in total, as a poly(3-hydroxybutyrate) resin with 0.5 parts by weight of B as a lubricant. The melting point of the resin pellets P-2 was 143° C. The melting point of the poly(3-hydroxybutyrate) resin, which was a mixture of A-3 and A-5, was also 143° C.

### (Weight-Average Molecular Weight)

The weight-average molecular weight of resin was measured in terms of polystyrene using the above-described gel permeation chromatography (HPLC GPC system manufactured by Shimadzu Corporation).

### (Glass Transition Temperature)

The glass transition temperature (Tg) of resin was determined by differential scanning calorimetry in accordance with JIS K-7121.

Specifically, about 5 mg of a sample to be measured was precisely weighed first, and the temperature was raised from-20° C. to 200° C. at a temperature increase rate of 10° C./min with a differential scanning calorimeter (SSC5200 manufactured by Seiko Instruments & Electronics Ltd.), and thus a DSC curve was obtained. Next, in the resulting DSC curve and specifically in a portion exhibiting a stepwise baseline shift arising from glass transition, straight extensions of the pre-shift baseline and the post-shift baseline were drawn, and a center line equidistant from the two straight extensions in the direction of the ordinate axis was drawn. The temperature at the point where the center line intersected the glass transition-induced stepwise shift portion of the DSC curve was determined as the glass transition temperature (Tg).

### (Melting Point)

The melting point was determined by differential scanning calorimetry in accordance with JIS K-7121.

Specifically, about 4 to 5 mg of a sample to be measured was precisely weighed first, and the temperature was raised from 0° C. to 180° C. at a temperature increase rate of 10° C./min with a differential scanning calorimeter (SSC5200 manufactured by Seiko Instruments & Electronics Ltd.), and thus a DSC curve was obtained. In the resulting DSC curve, the temperature at which the top of the melting point peak was located was determined as the melting point.

### (Thickness of Film)

The thickness of a film was measured using a caliper at 10 points spaced at intervals of 10 cm in the TD direction. An arithmetic mean of the 10 thickness values was calculated as the thickness of the film.

### (Amount of Film Shrinkage on Heating)

A film to be measured was cut into a square of 5 cm in MID direction x 5 cm in TD direction, and heated in an oven set at 110° C. for 10 minutes. Further, the dimensions of the film in the MD direction and the TD direction after heating were measured, and the amounts of shrinkage on heating in the MD and TD directions were determined by the following formulas. When the amount of shrinkage on heating was less than 10%, it was determined as ∘ (good), and when the amount of shrinkage on heating was 10% or more, it was determined as x (poor).

$$Amount of shrinkage on heating [ \% ] = ( 1 - ( dimension after heating ) / ( dimension before heating ) ) \times 100$$

### Example 1

A cylinder temperature and a die temperature of a 40-mm-diameter single-screw extruder to which a T die having a width of 350 mm was connected were set to 165° C. 60 parts by weight of the resin pellets P-1 and 40 parts by weight of polylactic acid (Ingeo 4060D manufactured by NatureWorks LLC., melting point: 210° C.) were dry-blended. The dry blend was charged into the single-screw extruder and melted, and the molten resin at a temperature of 165° C. was extruded into a film shape with a T-die. A film-shaped molten resin was extruded onto a cast roll set at 40° C. and molded at a haul-off speed of 2 m/min, and cooled to a film temperature of 30° C., and then the film was peeled off from the cast roll, affording a film having a thickness of about 300 μm.

The film peeled off from the cast roll was hauled with a haul-off roll, and continuously stretched by a roll longitudinal stretching machine at a film temperature of 60° C. during stretching such that a stretch ratio of 2.9 would be attained in the MD direction. The film temperature at that time was controlled by adjusting the roll temperature in the roll longitudinal stretching machine to the same temperature (60° C.). Subsequently, the film was continuously stretched by a clip-type tenter transverse stretching machine at a film temperature of 70° C. during stretching such that a stretching ratio of 4.5 would be attained in the TD direction. The film temperature at that time was controlled by applying hot air (airflow) at the same temperature (70° C.) to the film in the transverse stretching machine.

Subsequently, in the clip-type tenter transverse stretching machine, the film was subjected to heat treatment by hot air heating in which a film temperature was 130° C., a heating time was 10 seconds, a relaxation amount in the TD direction was 10%, and hot air at 130° C. was applied to the film, affording a biaxially stretched film having a thickness of 25 μm. As a result of measuring the amount of shrinkage on heating at 110° C. of the resulting film, the amount of shrinkage on heating in the MD direction was 2% and that in the TD direction was 7%, and the product was a superior film having an amount of shrinkage on heating as small as less than 10%. The results are shown in Table 1.

TABLE 1

| | Resin composition | | Stretching | | | | | | | |
|---|---|---|---|---|---|---|---|---|---|---|
| | Resin blend ratio | | conditions | | | | | | | |
| | | Polylactic | Stretch | Heat treatment conditions | | | | | | |
| | | acid | ratio | | | | Relaxation | | | |
| | P-1 | 4060D | MD | | | | amount | Amount of shrinkage on heating | | |
| | [parts | [parts | direction × | | | | (TD | MD | TD | |
| | by | by | TD direction | Treating | Temperature | Time | direction) | direction | direction | |
| | weight] | weight] | [times] | method | [° C.] | [sec] | [%] | [%] | [%] | Determination |
| Example 1 | 60 | 40 | 2.9 × 4.5 | Hot air | 130 | 10 | 10 | 2 | 7 | ∘ |
| Example 2 | | | | heating | 130 | 10 | 15 | 1 | 3 | ∘ |
| Example 3 | | | | | 153 | 10 | 10 | 2 | 2 | ∘ |
| Example 4 | 80 | 20 | 3 × 5 | | 120 | 10 | 15 | 2 | 6 | ∘ |
| Example 5 | | | | | 120 | 10 | 30 | 3 | 0 | ∘ |
| Comparative | 60 | 40 | 2.9 × 4.5 | Hot air | 110 | 10 | 10 | 6 | 10 | x |
| Example 1 | | | | heating | | | | | | |
| Comparative | 80 | 20 | 3 × 5 | | — | — | — | 26 | 50 | x |
| Example 2 | | | | | | | | | | |
| Comparative | | | | | 120 | 10 | 5 | 2 | 14 | x |
| Example 3 | | | | | | | | | | |
| Comparative | | | | | 120 | 10 | 60 | Generation of slack | | x |
| Example 4 | | | | | | | | | | |
| Comparative | | | | | 110 | 10 | 30 | 7 | 17 | x |
| Example 5 | | | | | | | | | | |

### Example 2 to 5, Comparative Example 1 to 5

Biaxially stretched films were obtained in the same manner as in Example 1 except that the resin composition, the stretch ratio and the heat treatment conditions were changed as shown in Table 1, and the amount of shrinkage on heating of the films obtained was measured. The results are shown in Table 1.

In Examples 1 to 5, in which the temperature of the heat treatment was in the range of 120° C. to 153° C., which falls in the range of (the melting point of the poly(3-hydroxybutyrate) resin−40° C.) or more and (the melting point of the poly(3-hydroxybutyrate) resin° C.) or less, and the relaxation amount was in the range of 10 to 30%, which falls in the range of 9 to 50%, superior biaxially stretched films having an amount of shrinkage on heating of less than 10% in both the MID direction and the TD direction could be obtained. On the other hand, in Comparative Example 2, since there was no heat treatment step, the amount of shrinkage on heating was 10% or more in both the MD direction and the TD direction. In Comparative Examples 1, 3, and 5, since the temperature of the heat treatment or the relaxation amount at the time of the heat treatment was low, a sufficient effect of the heat treatment was not obtained, and the amount of shrinkage on heating in the TD direction was 10% or more. In Comparative Example 4, since the relaxation amount at the time of the heat treatment was set as large as 60%, slack occurred in the film after the heat treatment. When slack occurs in the film, there is a risk that the film is broken by coming into contact with a production device including a heating appliance.

### Example 6

A cylinder temperature and a die temperature of a 40-mm-diameter single-screw extruder to which a T die having a width of 350 mm was connected were set to 165° C. 80 parts by weight of the resin pellets P-2 and 20 parts by weight of polylactic acid (Luminy LX175 manufactured by Total Corbion PLA, melting point: 151° C.) were dry-blended. The dry blend was charged into the single-screw extruder and melted, and the molten resin at a temperature of 165° C. was extruded into a film shape with a T-die. A film-shaped molten resin was extruded onto a cast roll set at 40° C. and molded at a haul-off speed of 2 m/min, and cooled to a film temperature of 40° C., and then the film was peeled off from the cast roll, affording a film having a thickness of about 300 μm.

The film peeled off from the cast roll was hauled with a haul-off roll, and continuously stretched by a roll longitudinal stretching machine at a film temperature of 60° C. during stretching such that a stretch ratio of 3 would be attained in the MID direction. The film temperature at that time was controlled by adjusting the roll temperature in the roll longitudinal stretching machine to the same temperature (60° C.). The resulting MD stretched film was cut into MD 90 mm x TD 350 mm, and stretched using a uniaxial stretching machine at a film temperature of 70° C. during stretching such that a stretching ratio of 5 would be attained in the TD direction. The film temperature at that time was controlled by applying hot air (airflow) at the same temperature (70° C.) to the film in the stretching machine.

Subsequently, in the uniaxial stretching machine, a preliminary heat treatment was performed by hot air heating in which a film temperature was 120° C., a heating time was 30 seconds, a relaxation amount in the TD direction was 0%, and hot air at 120° C. was applied to the film.

Subsequently, in the uniaxial stretching machine, a heat treatment was performed by hot air heating in which a film temperature was 120° C., a heating time was 30 seconds, a relaxation amount in the TD direction was 20%, and hot air at 120° C. was applied to the film, affording a biaxially stretched film having a thickness of 25 μm. As a result of measuring the amount of shrinkage on heating at 110° C. of the resulting film, the amount of shrinkage on heating in the MD direction was 2% and that in the TD direction was 4%, and the product was a superior film having an amount of shrinkage on heating as small as less than 10%. The results are shown in Table 2.

### Examples 7 to 10

Biaxially stretched films were obtained in the same manner as in Example 6 except that the presence or absence or the conditions of the preliminary heat treatment or the conditions of the heat treatment were changed as shown in Table 2, and the amount of shrinkage on heating of the films obtained was measured. The results are shown in Table 2.

TABLE 2

| | Resin composition | | Stretching | | | | | | |
|---|---|---|---|---|---|---|---|---|---|
| | Resin blend ratio | | conditions | | | | | | |
| | | Polylactic | Stretch | Preliminary heat treatment conditions | | | | | |
| | | acid | ratio | | | | Relaxation | | |
| | P-2 | LX175 | MD | | | | amount | Heat treatment conditions | |
| | [parts | [parts | direction × | | | | (TD | 1st | |
| | by | by | TD direction | Treating | Temperature | Time | direction) | Treatment | Temperature |
| | weight] | weight] | [times] | method | [° C.] | [sec] | [%] | method | [° C.] |
| Example 6 | 30 | 20 | 3 × 5 | Hot air | 120 | 30 | 0 | Hot air | 120 |
| Example 7 | | | | heating | 120 | 30 | 0 | heating | 130 |
| Example 8 | | | | — | — | — | — | Hot air | 120 |
| Example 9 | | | | — | — | — | — | heating | 120 |
| Example 10 | | | | — | — | — | — | | 120 |

| | Heat treatment conditions | | | | | | | | |
|---|---|---|---|---|---|---|---|---|---|
| | 1st | | 2nd | | | | | | |
| | | Relaxation | | | | Relaxation | | | |
| | | amount | | | | amount | Amount of shrinkage on heating | | |
| | | (TD | | | | (TD | MD | TD | |
| | Time | direction) | Treatment | Temperature | Time | direction) | direction | direction | |
| | [sec] | [%] | method | [° C.] | [sec] | [%] | [%] | [%] | Determination |
| Example 6 | 30 | 20 | — | — | — | — | 2 | 4 | □ |
| Example 7 | 30 | 20 | — | — | — | — | 1 | 6 | □ |
| Example 8 | 30 | 10 | Hot air | 120 | 30 | 20 | 2 | 8 | □ |
| Example 9 | 30 | 10 | heating | 130 | 30 | 20 | 0 | 8 | □ |
| Example 10 | 30 | 10 | | 130 | 30 | 30 | 0 | 2 | □ |

Resin compositionStretching cinditionsPreliminary heat
treatment conditionsHeat treatment conditionsAmount of shrinkage on heatingResin blend ratioStretchratio1st2ndP−2
[parts by weight]Polylactic acid LX175
[parts by weight]MID direction×TD direction
[times]Treating methodTemperature
[° C.]Time
[sec]Relaxation amount
(TD direction)
[%]Treatment
methodTemperature
[° C.]Time
[sec]Relaxation amount
(TD direction)
[%]Treatment
methodTemperature
[° C.]Time
[sec]Relaxation amount
(TD direction)
[%]MD direction
[%]TD direction
[%]DeterminationExample 680203 ×5Hot air heating120300Hot air heating1203020—24◯Example 71203001303020—16◯Example 8—Hot air heating1203010Hot air heating120302028◯Example 9—1203010130302008◯Example 10—1203010130303002◯Resin compositionStretching conditionsPreliminary heat treatment conditionsHeat treatment conditions Amount of shrinkage on heatingResin blend ratioStretch ratio1st2ndP−2
[parts by weight]Polylactic acid LX175
[parts by weight]MID direction×TD direction
[times]Treating methodTemperature
[° C.]Time
[sec]Relaxation amount
(TD direction)
[%]Treatment
methodTemperature
[° C.]Time
[sec]Relaxation amount
(TD direction)
[%]Treatment
methodTemperature
[° C.]Time
[sec]Relaxation amount
(TD direction)
[%]MD direction
[%]TD direction
[%]DeterminationExample 680203×5Hot air heating120300Hot air heating1203020—24◯Example 71203001303020—16◯Example 8—Hot air heating1203010Hot air heating1203020280Example 9—1203010130302008◯Example 10—1203010130303002◯

In Examples 6 to 10, in which the temperature of the heat treatment was in the range of 120° C. to 130° C., which falls in the range of (the melting point of the poly(3-hydroxybutyrate) resin−40° C.) or more and (the melting point of the poly(3-hydroxybutyrate) resin° C.) or less, and the relaxation amount was in the range of 10 to 30%, which falls in the range of 9 to 50%, superior biaxially stretched films having an amount of shrinkage on heating of less than 10% in both the MID direction and the TD direction could be obtained. In addition, by including a step of performing a preliminary heat treatment as in Examples 6 and 7, or by performing a two-stage heat treatment while increasing the relaxation amount stepwise as in Example 10, shrinkage on heating in the specific direction in which the film has been stretched in the step of stretching the film can be particularly reduced.

1. A method for producing a stretched film comprising a poly(3-hydroxybutyrate) resin, the method comprising:
melting a film raw material comprising the poly(3-hydroxybutyrate) resin with an extruder and molding the film raw material into a film shape;
stretching the molded film in a specific direction to obtain a stretched film;
performing a preliminary heat treatment before subjecting the stretched film to a heat treatment, wherein the preliminary heat treatment comprises heating the stretched film to a temperature in a range of from [a melting point of poly(3-hydroxybutyrate) resin−40° C.] to [the melting point of poly(3-hydroxybutyrate) resin]° C. by a non-contact heating technique with a relaxation amount in the specific direction represented by the following formula (ii) of from 0% to less than 9%:
Relaxation amount [%]={(film dimension in specific direction before preliminary heat treatment)−(film dimension in specific direction during preliminary heat treatment)}/(film dimension in specific direction before preliminary heat treatment)×100 (ii), and
subjecting the stretched film to a heat treatment,
wherein the heat treatment comprises heating the stretched film to a temperature in a range of from [the melting point of the poly(3-hydroxybutyrate) resin−40° C.] to [the melting point of the poly(3-hydroxybutyrate) resin]° C. by a non-contact heating technique with a relaxation amount in the specific direction represented by a following formula (i) of 9 to 50%:
Relaxation amount [%]={(film dimension in specific direction before heat treatment)−(film dimension in specific direction during heat treatment)}/(film dimension in specific direction before heat treatment)×100 (i).

2. The method according to claim 1, wherein a time of heating in the heat treatment is from 1 to 180 seconds.

3. The method according to claim 1, wherein the non-contact heating technique is hot air heating or infrared radiation heating.

4. The method according to claim 1, wherein the stretching is biaxial stretching.

5. The method according to claim 1, wherein the molding through the heat treatment are performed in a continuous process.

6. The method according to claim 1, wherein a stretch ratio of the film in the specific direction in the stretching is from 1.1 to 8.

7. The method according to claim 1, wherein the poly(3-hydroxybutyrate) resin comprises poly(3-hydroxybutyrate-co-3-hydroxyhexanoate).

8. (canceled)

9. The method according to claim 1, wherein in subjecting the stretched film to the heat treatment, the heat treatment comprises adjusting the relaxation amount in the specific direction represented by the formula (i) to R1 and then to R2, wherein the relaxation amounts R1 and R2 satisfy 9%≤R1≤50%, 9%≤R2≤50%, and R1<R2−R1.

10. The method according to claim 9, wherein in subjecting the stretched film to the heat treatment, the relaxation amount R2 satisfies 9%≤R2≤30%.

11. The method according to claim 1, wherein the heat treatment comprises bringing the film to a temperature T1 and then to a temperature T2, wherein the temperatures T1 and T2 satisfy a condition represented by the following formula:
(Melting point of poly(3-hydroxybutyrate) resin−40° C.)≤T1<T2≤(melting point of poly(3-hydroxybutyrate) resin)° C.

12. The method according to claim 11, wherein in subjecting the stretched film to the heat treatment, the heat treatment comprises adjusting the relaxation amount in the specific direction represented by the formula to R1, and then to R2,
the relaxation amounts R1 and R2 satisfy 9%≤R1≤50%, 9%≤R2≤50%, and R1<R2-R1, and
the film is adjusted to a temperature T1 with the relaxation amount R1, and the film is adjusted to a temperature T2 with the relaxation amount R2.
